(19) United States
(12) Patent Application Publication
(10) Pub. No.: US 2019/0065431 A1
(43) Pub. Date: Feb. 28, 2019

(54) PROVIDING ZERO-OVERHEAD FRAME SYNCHRONIZATION USING SYNCHRONIZATION STROBE POLARITY FOR SOUNDWIRE EXTENSION BUSES

(71) Applicant: QUALCOMM Incorporated, San Diego, CA (US)

(72) Inventors: Lior Amarilio, Yokneam (IL); Chulkyu Lee, San Diego, CA (US); Harvijaysinh Raj, San Diego, CA (US)

(21) Appl. No.: 16/056,885

(22) Filed: Aug. 7, 2018

Related U.S. Application Data
(60) Provisional application No. 62/552,739, filed on Aug. 31, 2017.

(51) Int. Cl. G06F 13/42; G06F 3/16; G06F 1/12

(52) U.S. Cl. CPC G06F 13/4295; G06F 13/4291; H04L 27/2656; G06F 1/12; G06F 3/162

(57) ABSTRACT

Providing zero-overhead frame synchronization using synchronization strobe polarity for SOUNDWIRE Extension buses is disclosed. In one aspect, a downstream-facing interface (DFI) device determines a polarity of a next synchronization strobe of a bitstream based on a value of a next frame synchronization pattern, and adjusts the next synchronization strobe of the bitstream to comprise a signal transition corresponding to the polarity. The processor-based DFI device then transmits the bitstream containing the next synchronization strobe (e.g., via a SOUNDWIRE Extension bus, such as a SOUNDWIRE-XL or SOUNDWIRE-NEXT bus, to one or more upstream-facing interface (UFI) devices). In another aspect, a processor-based UFI device receives the bitstream, and detects the encoded polarity of the synchronization strobe. The processor-based UFI device reconstructs the frame synchronization pattern based on the polarity of the synchronization strobe, and performs frame synchronization based on the frame synchronization pattern.

### PRIORITY APPLICATION

The present application claims priority under 35 U.S.C. § 119(e) to U.S. Provisional Patent Application Ser. No. 62/552,739 entitled “PROVIDING ZERO-OVERHEAD FRAME SYNCHRONIZATION USING SYNCHRONIZATION STROBE POLARITY FOR SOUNDWIRE-XL BUSES” and filed on Aug. 31, 2017, the contents of which is incorporated herein by reference in its entirety.

### BACKGROUND

### I. Field of the Disclosure

The technology of the disclosure relates generally to a SOUNDWIRE audio bus, and, in particular, to frame synchronization for audio buses employing a SOUNDWIRE Extension protocol, such as SOUNDWIRE-XL or SOUNDWIRE-NEXT.

### II. Background

Mobile terminals are become increasingly common in modern society, having evolved from large, clunky, relatively simple telephonic devices into small, full range, multimedia devices with vastly improved processing power. Early mobile terminals generally provided poor sound quality and little, if any, visual image capacity. However, as both the processing power for these mobile terminals and the range of multimedia options has increased, the quality of the possible audio experience has likewise increased. In particular, contemporaneous mobile terminals may include multiple speakers, multiple microphones and, optionally, may communicate with remote audio devices such as headsets.

The MIPI® Alliance introduced the Serial Low Power Inter-chip Media Bus (SLIMbus®) protocol to help standardize communications among audio elements of a mobile terminal. SLIMbus has proved effective at providing communications among audio elements of a mobile terminal, but nevertheless has not seen widespread acceptance by the industry. Accordingly, to provide an alternative or supplement to the SLIMbus protocol, the MIPI Alliance has introduced the SOUNDWIRE specification. The SOUNDWIRE specification provides for a two-wire physical communications bus up to fifty centimeters in length, which is sufficient to house the audio elements within the mobile terminal. However, such distances may be too short for some regularly used ancillary devices, such as a headset. The MIPI Alliance thus has proposed a SOUNDWIRE Extension specification (“SOUNDWIRE Extension”), initially designated as SOUNDWIRE-XL, to enable communications over greater distances. Subsequent to this date, the MIPI Alliance changed the designation of the SOUNDWIRE Extension specification from SOUNDWIRE-XL to SOUNDWIRE-NEXT. It should be appreciated that such nomenclature may be subject to further renaming. At the time of this writing, the SOUNDWIRE Extension specification is at version 0.1 revision 1, published Jun. 8, 2016.

Implementations of the SOUNDWIRE-XL iteration of the SOUNDWIRE Extension specification employed a differential bi-directional clock-embedded physical link bus to transmit a bitstream between a downstream-facing interface (DFI) device (e.g., a master device) and one or more upstream-facing interfaces (UFIs) device (e.g., slave devices). The bitstream can be conceptualized as bitslots arranged horizontally in a row, with successive rows arranged vertically so that repeating features of the bitstream (e.g., synchronization strobe bits and data bits) are visible in columns of bitslots. The DFI inserts synchronization strobe bits into the bitstream for use by the UFI(s) in reconstructing a clock using a phase-locked loop (PLL) or a delay locked loop (DLL), and also provides frame synchronization patterns to enable frame synchronization by the UFI(s). However, each of the frame synchronization patterns conventionally occupies an entire bitslot within each row of the bitstream. Because rows may comprise as few as eight (8) or sixteen bitslots in some aspects, the frame synchronization patterns consequently may consume a relatively large portion of available transport bandwidth. This issue remains present in the current SOUNDWIRE-NEXT iteration of the SOUNDWIRE Extension specification.

### SUMMARY OF THE DISCLOSURE

Aspects disclosed in the detailed description include providing zero-overhead frame synchronization using synchronization strobe polarity for SOUNDWIRE Extension buses. In this regard, in one aspect, a processor-based downstream-facing interface (DFI) device (also referred to as a “master device” or “master”) is configured to determine a polarity of a next synchronization strobe of a bitstream based on a value of a next frame synchronization pattern. The processor-based DFI device adjusts the next synchronization strobe of the bitstream to comprise a signal transition corresponding to the polarity. In some aspects, a low-to-high signal transition may correspond to a frame synchronization pattern value of zero (0) and a high-to-low signal transition may correspond to a frame synchronization pattern of one (1), while some aspects may interpret a low-to-high signal transition as corresponding to a frame synchronization pattern value of one (1) and a high-to-low signal transition as corresponding to a frame synchronization pattern of zero (0). The processor-based DFI device then transmits the bitstream containing the next synchronization strobe (e.g., via a SOUNDWIRE Extension bus to one or more upstream-facing interface (UFI) devices, also referred to as a “slave device” or “slave”). In another aspect, a processor-based UFI device receives the bitstream, and detects the encoded polarity of the synchronization strobe. The processor-based UFI device reconstructs the frame synchronization pattern based on the polarity of the synchronization strobe, and performs frame synchronization based on the frame synchronization pattern.

In another aspect, a processor-based DFI device is provided. The processor-based DFI device comprises an application processor that comprises a control circuit and a bus interface, and that is communicatively coupled to a bus. The application processor is configured to determine, by the control circuit of the application processor, a polarity of a next synchronization strobe of a bitstream based on a value of a next frame synchronization pattern. The application processor is further configured to adjust the next synchronization strobe of the bitstream to comprise a signal transition corresponding to the polarity. The application processor is also configured to transmit the bitstream containing the next synchronization strobe via the bus.

In another aspect, a method for encoding frame synchronization patterns is provided. The method comprises determining, by a DFI device, a polarity of a next synchronization strobe of a bitstream based on a value of a next frame synchronization pattern. The method further comprises adjusting the next synchronization strobe of the bitstream to comprise a signal transition corresponding to the polarity. The method also comprises transmitting the bitstream containing the next synchronization strobe via a bus.

In another aspect, a processor-based UFI device is provided. The processor-based UFI device comprises an application processor that comprises a control circuit and a bus interface, and that is communicatively coupled to a bus. The application processor is configured to receive, by the control circuit of the application processor, a bitstream comprising a synchronization strobe via the bus. The application processor is further configured to detect a polarity of the synchronization strobe indicated by a signal transition of the synchronization strobe. The application processor is also configured to reconstruct a frame synchronization pattern based on the polarity of the synchronization strobe. The application processor is additionally configured to perform frame synchronization based on the frame synchronization pattern.

In another aspect, a method for decoding frame synchronization patterns is provided. The method comprises receiving, by a processor-based UFI device, a bitstream comprising a synchronization strobe via a bus. The method further comprises detecting a polarity of the synchronization strobe indicated by a signal transition of the synchronization strobe. The method also comprises reconstructing a frame synchronization pattern based on the polarity of the synchronization strobe. The method additionally comprises performing frame synchronization based on the frame synchronization pattern.

### BRIEF DESCRIPTION OF THE FIGURES

FIG. 1 is a block diagram of an exemplary SOUNDWIRE Extension system with both a SOUNDWIRE bus and a SOUNDWIRE Extension bus;

FIG. 2 is a block diagram of an exemplary SOUNDWIRE Extension bitstream employing conventional synchronization strobes and frame synchronization patterns;

FIG. 3 is a block diagram of an exemplary processor-based downstream-facing interface (DFI) device and a processor-based upstream-facing interface (UFI) device configured to communicate using zero-overhead frame synchronization;

FIGS. 4A and 4B are block diagrams of exemplary zero-overhead frame synchronization based on a polarity of a synchronization strobe;

FIG. 5 is a flowchart illustrating exemplary operations of the processor-based DFI device of FIG. 3 for providing zero-overhead frame synchronization using synchronization strobe polarity;

FIG. 6 is a flowchart illustrating exemplary operations of the processor-based UFI device of FIG. 3 for decoding a frame synchronization pattern from synchronization strobe polarity;

FIG. 7 is a block diagram illustrating an exemplary device employing a SOUNDWIRE Extension bus; and

FIG. 8 is a block diagram of an exemplary processor-based system that can comprise the processor-based DFI device and/or the processor-based UFI device of FIG. 3 for providing zero-overhead frame synchronization using synchronization strobe polarity.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include providing zero-overhead frame synchronization using synchronization strobe polarity for SOUNDWIRE Extension buses. In this regard, in one aspect, a processor-based downstream-facing interface (DFI) device (also referred to as a “master device” or “master”) is configured to determine a polarity of a next synchronization strobe of a bitstream based on a value of a next frame synchronization pattern. The processor-based DFI device adjusts the next synchronization strobe of the bitstream to comprise a signal transition corresponding to the polarity. In some aspects, a low-to-high signal transition may correspond to a frame synchronization pattern value of zero (0) and a high-to-low signal transition may correspond to a frame synchronization pattern of one (1), while some aspects may interpret a low-to-high signal transition as corresponding to a frame synchronization pattern value of one (1) and a high-to-low signal transition as corresponding to a frame synchronization pattern of zero (0). The processor-based DFI device then transmits the bitstream containing the next synchronization strobe (e.g., via a SOUNDWIRE Extension bus to one or more upstream-facing interface (UFI) devices, also referred to as a “slave device” or “slave”). In another aspect, a processor-based UFI device receives the bitstream, and detects the encoded polarity of the synchronization strobe. The processor-based UFI device reconstructs the frame synchronization pattern based on the polarity of the synchronization strobe, and performs frame synchronization based on the frame synchronization pattern.

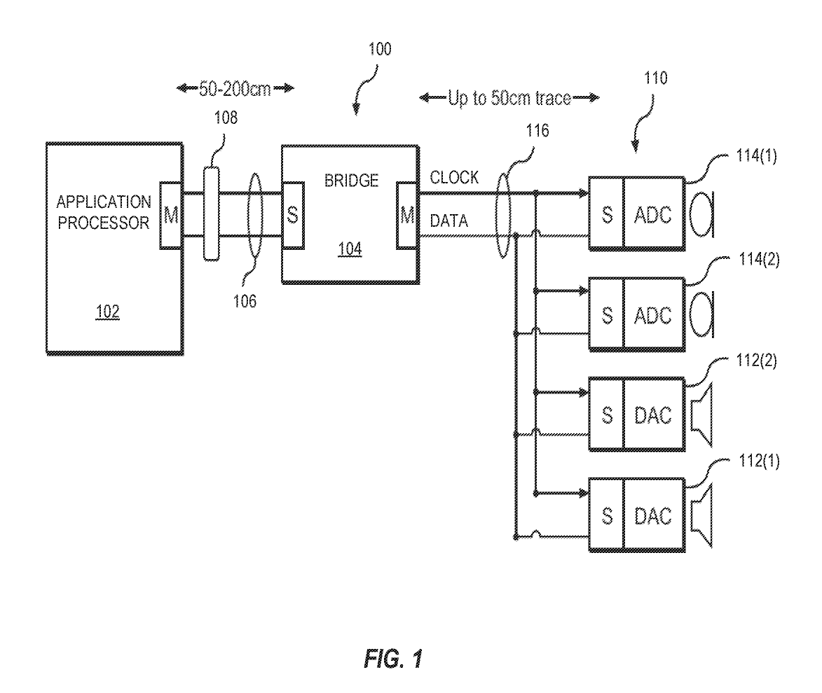

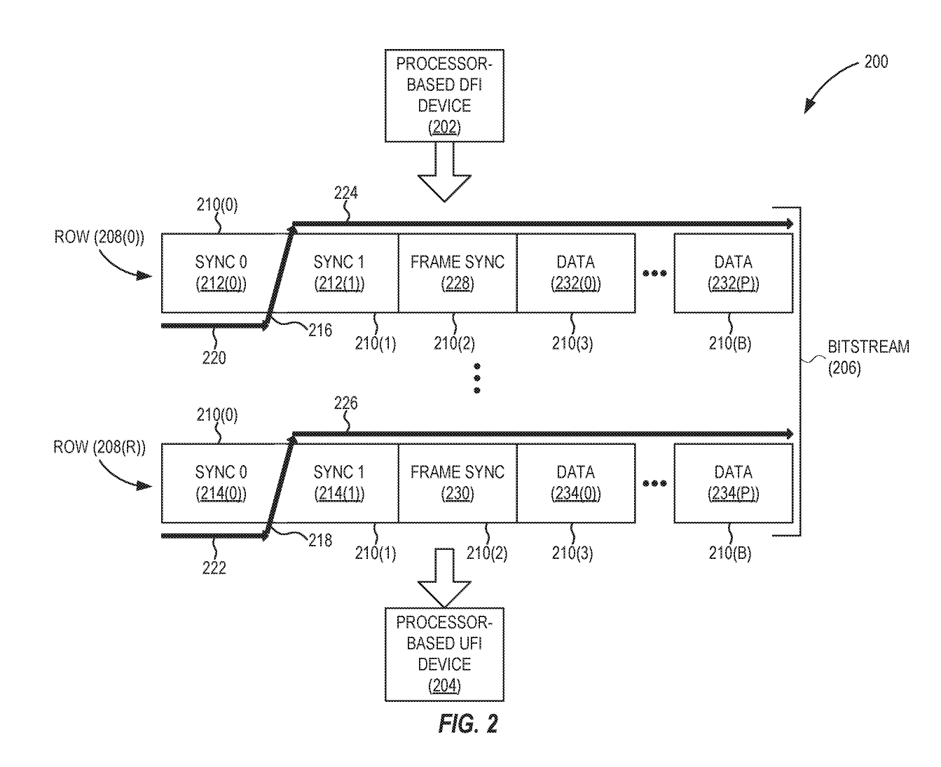

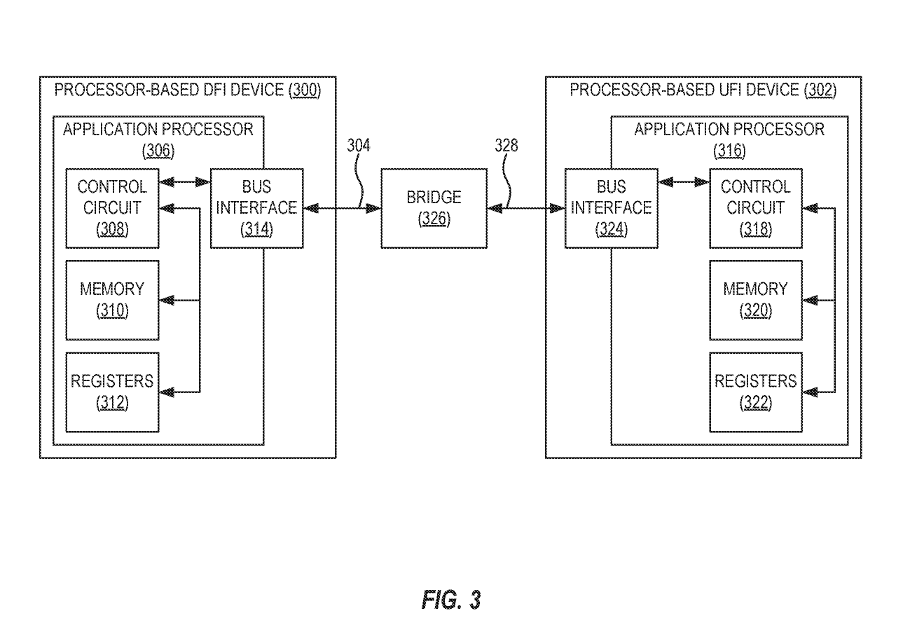

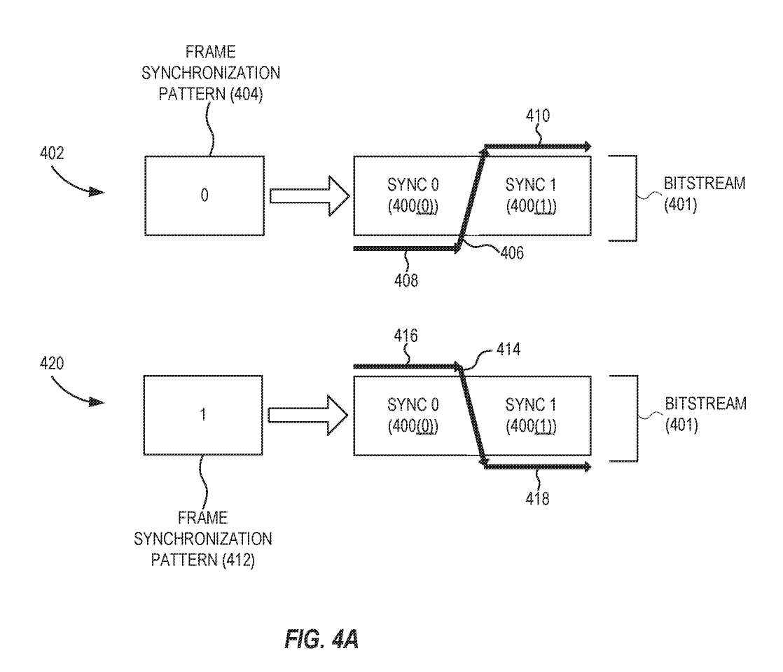

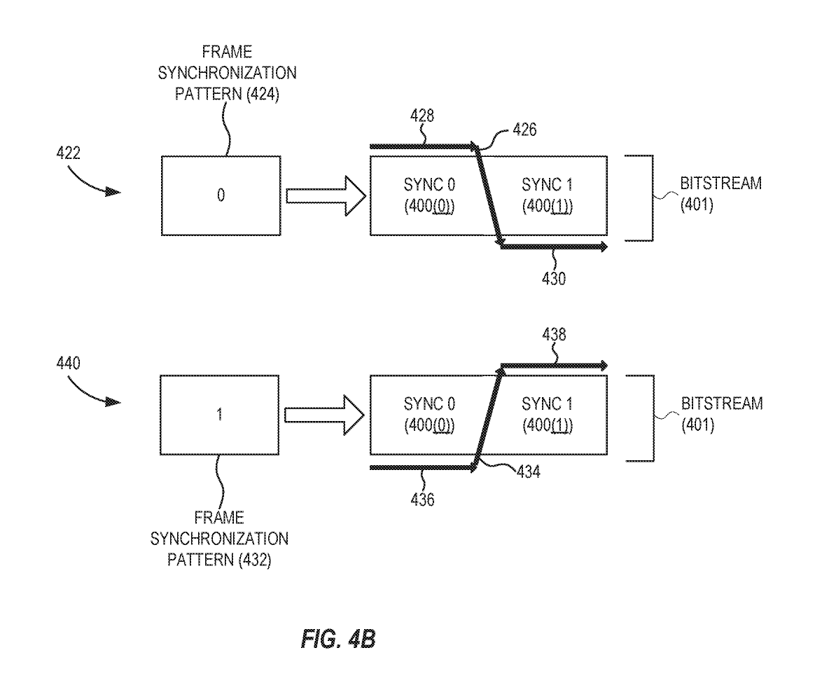

Before describing how synchronization strobe polarity is used for zero-overhead frame synchronization, elements of a conventional SOUNDWIRE Extension system, as well as the operations of and interactions between a conventional SOUNDWIRE Extension downstream-facing interface (DFI) device and a conventional upstream-facing interface (UFI) device, are first discussed. It should be appreciated that, during preparation of the incorporated parent provisional application, the designation for the SOUNDWIRE Extension specification was SOUNDWIRE-XL. As noted above, the designation has since migrated to SOUNDWIRE-NEXT, although the relevant portions of the specifications are identical. For the sake of clarity, the term “SOUNDWIRE Extension” is used herein to refer to the SOUNDWIRE-XL and SOUNDWIRE-NEXT specifications containing the relevant portions referenced herein, as well as to future iterations of the specification that also include the relevant portions referenced herein. In this regard, FIG. 1 illustrates a conventional SOUNDWIRE Extension system, while FIG. 2 illustrates an exemplary internal structure of a bitstream being communicated between a conventional processor-based DFI device and a conventional processor-based UFI device. FIG. 3 then illustrates a processor-based DFI device and a processor-based UFI device for providing zero-overhead frame synchronization as disclosed herein, and FIGS. 4A and 4B illustrate exemplary encoding schemes for encoding frame synchronization data.

Referring now to FIG. 1, a conventional SOUNDWIRE Extension system 100 comprising both a SOUNDWIRE bus and a SOUNDWIRE Extension bus is shown. The SOUNDWIRE Extension system 100 enables long-distance connections as provided by the MIPI Alliance's proposed SOUNDWIRE Extension specification (which, as of this writing, is designated SOUNDWIRE-NEXT, is at version 0.1, revision 1, published Jun. 8, 2016, and is hereby incorporated by reference in its entirety). The SOUNDWIRE Extension system 100 of FIG. 1 includes an application processor 102 that is coupled to a bridge 104 by a long cable 106. In some aspects, the application processor 102 referenced herein may comprise a codec. The long cable 106 and other long cables described herein are sometimes referred to as “digital audio cables,” as a non-limiting example. In an exemplary aspect, the long cable 106 is expected to be greater than 50 centimeters (cm) (although it may be shorter and still work with exemplary aspects of the present disclosure), but less than two (2) meters (m) (or 200 cm), and may use a 3 5 millimeter (mm) audio jack, a Universal Serial Bus (USB) connector 108 (e.g., Type-C or micro-USB, as non-limiting examples), or other proprietary type of cable or connector. The bridge 104 acts as a master device for a SOUNDWIRE sub-system 110.

The SOUNDWIRE sub-system 110 may include a plurality of microphones 112(1)-112(2) and a plurality of speakers 114(1)-114(2) (as well as any other audio components) comprising slave devices within the SOUNDWIRE sub-system 110. In an exemplary aspect, the SOUNDWIRE sub-system 110 may be instantiated in a headset. The bridge 104 may include a control system that enables signal conversion between the long cable 106 and the SOUNDWIRE sub-system 110. The bridge 104 is coupled to the plurality of microphones 112(1)-112(2) and the plurality of speakers 114(1)-114(2) via a multi-wire bus 116 that is compliant with the SOUNDWIRE specification (i.e., a multi-wire bus, including a clock line and one or more data lines, and having a length less than 50 cm). In an exemplary aspect, the long cable 106 uses a SOUNDWIRE Extension protocol described below, and the bridge 104 converts messages in the SOUNDWIRE Extension protocol from the application processor 102 to a SOUNDWIRE protocol and converts messages in the SOUNDWIRE protocol from the SOUNDWIRE sub-system 110 to the SOUNDWIRE Extension protocol. It is to be understood that the application processor 102 may be a native SOUNDWIRE element, and may operate with the SOUNDWIRE Extension protocol through a protocol conversion using an internal bridge or may directly populate signals using the SOUNDWIRE Extension protocol.

To illustrate an exemplary SOUNDWIRE Extension bitstream employing conventional synchronization strobes and frame synchronization patterns, FIG. 2 is provided. FIG. 2 provides a block diagram 200 illustrating a processor-based DFI device 202 and a processor-based UFI device 204 communicating via a bitstream 206 according to the SOUNDWIRE Extension specification. The processor-based DFI device 202, which in this example may be considered a “master” device, is configured to generate synchronization and control information for a SOUNDWIRE Extension segment (i.e., the logical and physical connection between the processor-based DFI device 202 and the processor-based UFI device 204). The processor-based UFI device 204, acting as a “slave” device, is configured to receive the synchronization and control information for the SOUNDWIRE Extension segment. The processor-based DFI device 202 and the processor-based UFI device 204 of FIG. 2 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor sockets or packages. It is to be understood that some aspects of the processor-based DFI device 202 and the processor-based UFI device 204 may include elements in addition to those illustrated in FIG. 2. Additionally, the processor-based DFI device 202 may be communicatively coupled to more than the one processor-based UFI device 204 than shown in FIG. 2.

While the bitstream 206 comprises a continuous signal through the physical medium, the bitstream 206 can be conceptualized as quantized symbols (i.e., synchronization strobes and data bits) and bitslots in which those symbols may be transmitted. Because the bitstream 206 contains features that are repeated at regular intervals, it may be represented visually as bitslots in a rectangular structure, wherein successive bitslots are shown horizontally within a row and successive rows are arranged vertically so that repeating features are visible in columns of bitslots. Accordingly, as seen in FIG. 2, the bitstream 206 is represented as a plurality of rows 208(0)-208(R), each made up of bitslots 210(0)-210(B).

The bitstream 206 is communicated between the processor-based DFI device 202 and the processor-based UFI device 204 via a differential bi-directional clock-embedded physical link bus (not shown). To enable the processor-based UFI device 204 to reconstruct a transport clock (e.g., having a frequency equal to or larger than the rate of the bitslots 210(0)-210(B), as a non-limiting example), the processor-based DFI device 202 inserts synchronization strobes, indicated by a transition between a synchronization bit 0 (e.g., synchronization (“SYNC 0”) bits 212(0), 214(0)) and a synchronization bit 1 (e.g., synchronization (“SYNC 1”) bits 212(1), 214(1)), at pre-determined positions. For the sake of clarity, the pairs of synchronization bits 212(0), 212(1) and 214(0), 214(1) may each be referred to herein as a “synchronization strobe.” In the example of FIG. 2, values of the synchronization strobes in the rows 208(0)-208(R) are encoded by the processor-based DFI device 202 as rising edges 216, 218, which represent the bitstream 206 signal transitioning from low states 220, 222 to high states 224, 226. The processor-based UFI device 204 detects the rising edges 216, 218, and reconstructs the clock phase and frequency using, for example, a phased-locked loop (PLL) or a delay locked loop (DLL) (not shown). According to the SOUNDWIRE-NEXT specification, a synchronization strobe (e.g., the SYNC 0 bits 212(0), 214(0) and the SYNC 1 bits 212(1), 214(1)), if present, occupies the first two bitslots (e.g. the bitslots 210(0)-210(1)) of each row 208(0)-208(R) of the bitstream 206.

In the example of FIG. 2, one or more of the rows 208(0)-208(R) also includes a frame synchronization pattern (“FRAME SYNC”) 228, 230 occupying the next bitslot 210(2) following the SYNC 0 bits 212(0), 214(0) and the SYNC 1 bits 212(1), 214(1). It is to be understood that some aspects may provide that the frame synchronization patterns 228, 230 may occupy other bitslots 210(0)-210(B) instead of the bitslot 210(2) as shown in FIG. 2. In some aspects, the frame synchronization patterns 228, 230 are based on a combination of static and dynamic frame synchronization patterns provided by a linear feedback shift register (LFSR) (not shown), and are inserted into the bitstream 206 by the processor-based DFI device 202. The frame synchronization patterns 228, 230 enable the processor-based UFI device 204 to perform frame synchronization to identify and extract data bits (“DATA”) 232(0)-232(P), 234(0)-234(P) from the bitslots 210(3)-210(B) of the rows 208(0)-208(R) of the bitstream 206.

However, one disadvantage of conventional bitstreams such as the bitstream 206 of FIG. 2 is that each of the frame synchronization patterns 228, 230 occupies an entire bitslot 210(2) of the corresponding row 208(0), 208(R). Consequently, in aspects in which each of the rows 208(0)-208(R) contains only eight (8) or 16 bitslots 210, the frame synchronization patterns 228, 230 may consume a relatively large portion of the available transport bandwidth. It is therefore desirable to provide a more efficient mechanism for encoding frame synchronization patterns within bitstreams.

In this regard, FIG. 3 illustrates a processor-based DFI device 300 and a processor-based UFI device 302 configured to provide zero-overhead frame synchronization using synchronization strobe polarity via a SOUNDWIRE Extension bus 304. The processor-based DFI device 300 and the processor-based UFI device 302 correspond in functionality to the processor-based DFI device 202 and the processor-based UFI device 204 of FIG. 2, except the processor-based DFI device 300 and the processor-based UFI device 302 are configured to use a polarity of the synchronization strobe represented by synchronization bits to indicate a frame synchronization pattern that would conventionally be encoded by the frame synchronization patterns 228, 230 of FIG. 2. As used herein, the “polarity” of the synchronization strobe represented by the synchronization bits refers to the direction of transition (e.g., low-to-high or high-to-low) of the signal edge between a first synchronization bit and a second synchronization bit. The processor-based DFI device 300 and the processor-based UFI device 302 are configured to recognize a given transition (e.g., a low-to-high transition or rising edge, as a non-limiting example) between synchronization bits as a value of zero (0), and to recognize the inverse of the transition (e.g., a high-to-low transition or falling edge, as a non-limiting example) as a value of one (1). In this manner, the synchronization strobe represented by the synchronization bits enables clock recovery by the processor-based UFI device 302, and also encodes frame synchronization patterns allowing bitslots conventionally used to store frame synchronization patterns to be repurposed to store control or data bits. Examples of encoding frame synchronization patterns using the polarity of synchronization strobes are discussed below in greater detail with respect to FIGS. 4A and 4B.

As seen in FIG. 3, the processor-based DFI device 300 includes an application processor 306 that comprises a control circuit 308, a memory 310, and registers 312. The control circuit 308 of the application processor 306 embodies logic employed by the application processor 306 for encoding frame synchronization patterns into a bitstream, which is then transmitted to the processor-based UFI device 302 via a bus interface 314 that is communicatively coupled to the SOUNDWIRE Extension bus 304. The memory 310, in some aspects, may comprise double-data-rate synchronous dynamic random-access memory (DDR SDRAM), as a non-limiting example. The registers 312 according to some aspects may comprise a plurality of control registers used by the application processor 306 to modify or control the operations of the control circuit 308. The processor-based UFI device 302 also includes an application processor 316 that comprises a control circuit 318, a memory 320, registers 312, and a bus interface 324. The control circuit 318 embodies logic employed by the application processor 316 for decoding frame synchronization patterns, while the memory 320, the registers 322, and the bus interface 324 correspond in functionality to the memory 310, the registers 312, and the bus interface 314 of the processor-based DFI device 300. It is to be understood that the application processor 306 of the processor-based DFI device 300 and the application processor 316 of the processor-based UFI device 302 may include more or fewer elements than those illustrated in FIG. 3.

Bitstreams encoded and transmitted by the processor-based DFI device 300 are relayed by a bridge 326, which corresponds in functionality to the bridge 104 of FIG. 1. In particular, the bridge 326 in some aspects is responsible for converting a bitstream transmitted in the SOUNDWIRE Extension protocol from the application processor 306 to a SOUNDWIRE protocol for transmission over a SOUNDWIRE bus 328. Similarly, the bridge 326 converts messages in the SOUNDWIRE protocol received from the processor-based UFI device 302 to the SOUNDWIRE Extension protocol for transmission over the SOUNDWIRE Extension bus 304.

To illustrate exemplary zero-overhead frame synchronization based on a polarity of a synchronization strobe as provided by the processor-based DFI device 300 and the processor-based UFI device 302 of FIG. 3, FIGS. 4A and 4B are provided. FIGS. 4A and 4B illustrate a synchronization strobe represented by a SYNC 0 bit 400(0) and a SYNC 1 bit 400(1) (corresponding in functionality to the SYNC 0 bit 212(0) and the SYNC 1 bit 212(1), respectively, of FIG. 2) of a bitstream 401. As indicated by arrow 402 in FIG. 4A, a frame synchronization pattern 404 having a value of zero (0) is encoded (e.g., by the processor-based DFI device 202) as a signal transition 406 from a low signal state 408 to a high signal state 410 (i.e., a rising edge) between the SYNC 0 bit 400(0) and the SYNC 1 bit 400(1). Conversely, a frame synchronization pattern 412 having a value of one (1) is encoded as a signal transition 414 from a high signal state 416 to a low signal state 418 (i.e., a falling edge) between the SYNC 0 bit 400(0) and the SYNC 1 bit 400(1), as indicated by arrow 420.

FIG. 4B illustrates an alternate encoding and interpretation of the synchronization strobe represented by the SYNC 0 bit 400(0) and the SYNC 1 bit 400(1). As indicated by arrow 422 in FIG. 4B, a frame synchronization pattern 424 having a value of zero (0) is encoded as a transition 426 from a high signal state 428 to a low signal state 430 (i.e., a falling edge) between the SYNC 0 bit 400(0) and the SYNC 1 bit 400(1). A frame synchronization pattern 432 having a value of one (1) is encoded as a transition 434 from a low signal state 436 to a high signal state 438 (i.e., a rising edge) between the SYNC 0 bit 400(0) and the SYNC 1 bit 400(1), as indicated by arrow 440.

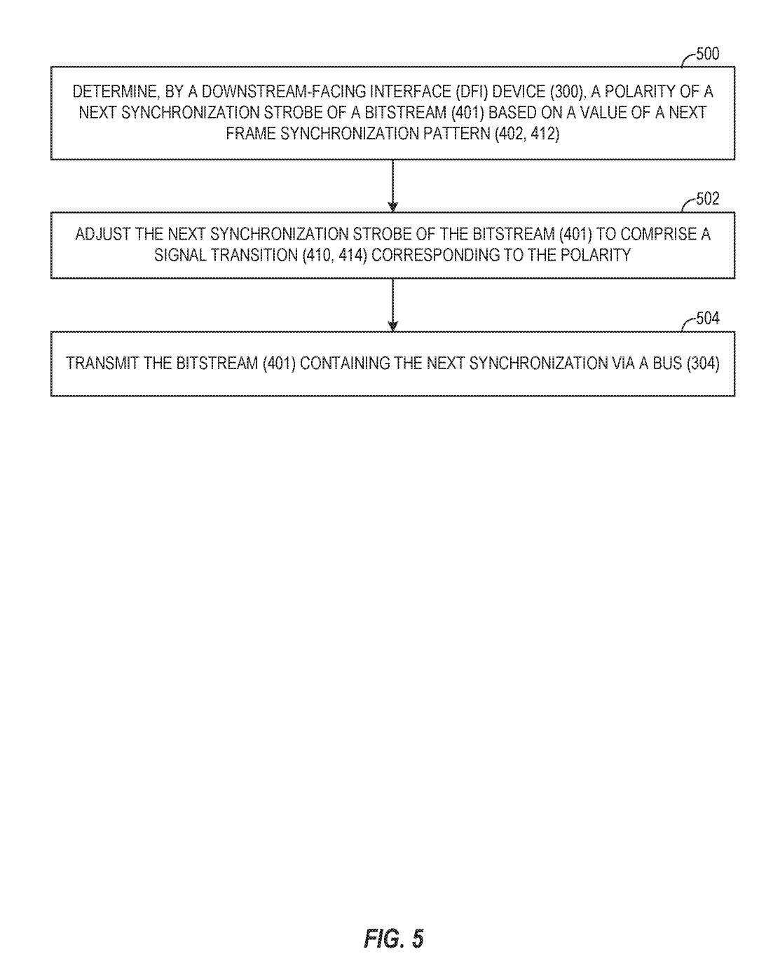

FIG. 5 illustrates exemplary operations of the processor-based DFI device 300 of FIG. 3 for providing zero-overhead frame synchronization using synchronization strobe polarity. Elements of FIGS. 3 and 4A-4B are referenced in describing FIG. 5 for the sake of clarity. In FIG. 5, operations begin with the processor-based DFI device 300 of FIG. 3 determining the polarity of a next synchronization strobe (e.g., the synchronization strobe represented by the SYNC 0 bit 400(0) and the SYNC 1 bit 400(1) of FIGS. 4A-4B) based on the value of the next frame synchronization pattern, such as the frame synchronization patterns 404, 412 of FIG. 4A (block 500). The processor-based DFI device 300 then adjusts the next synchronization strobe to comprise a signal transition (e.g., the signal transitions 406, 414) corresponding to the polarity (block 502). For instance, if the encoding scheme illustrated in FIG. 4A is in use, the processor-based DFI device 300 may adjust the synchronization strobe to comprise a rising edge to represent the frame synchronization pattern 404 having a value of zero (0), or may adjust the synchronization strobe to comprise a falling edge to represent the frame synchronization pattern 412 having a value of one (1). The processor-based DFI device 300 then transmits the bitstream 401 containing the next synchronization strobe (block 504).

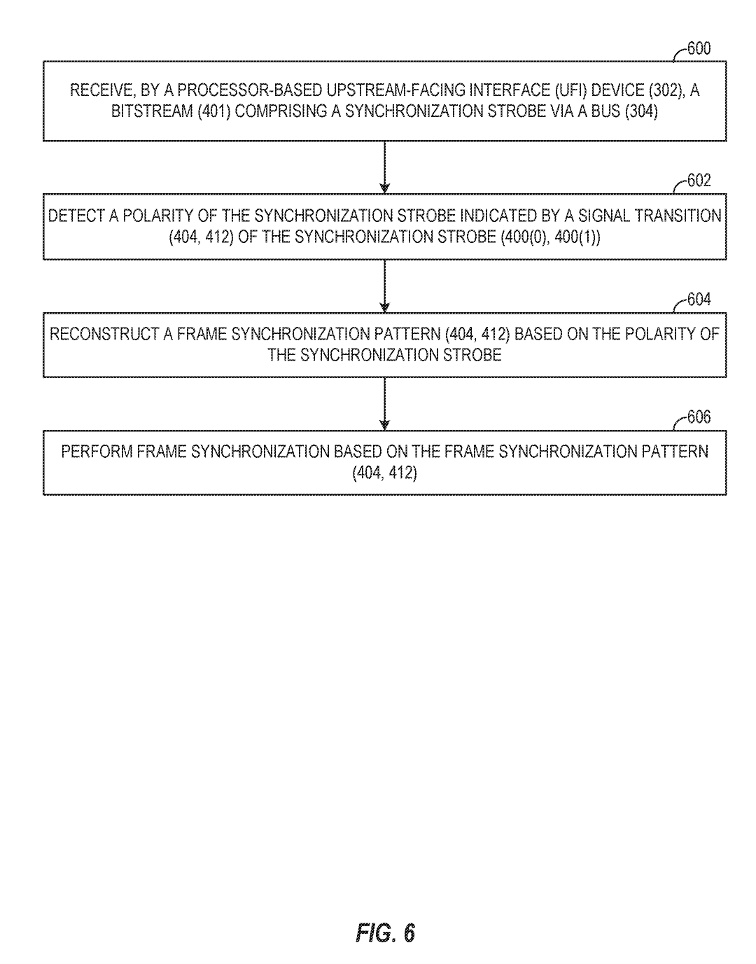

To illustrate exemplary operation of the processor-based UFI device 302 of FIG. 3 for decoding frame synchronization data from synchronization strobe polarity, FIG. 6 is provided. For the sake of clarity, elements of FIGS. 3 and 4A-4B are referenced in describing FIG. 6. Operations in FIG. 6 begin with the processor-based UFI device 302 receiving the bitstream 401 comprising the synchronization strobe (e.g., the synchronization strobe represented by the SYNC 0 bit 400(0) and the SYNC 1 bit 400(1) of FIGS. 4A-4B) (block 600). The processor-based UFI device 302 detects the polarity of the synchronization strobe indicated by a signal transition, such as the signal transitions 406, 414, of the synchronization strobe (block 602). The processor-based UFI device 302 then reconstructs the frame synchronization pattern (e.g., the frame synchronization patterns 404, 412 of FIG. 4A) based on the polarity of the synchronization strobe (block 604). Finally, the processor-based UFI device 302 then performs frame synchronization based on the frame synchronization pattern 404, 412 (block 606).

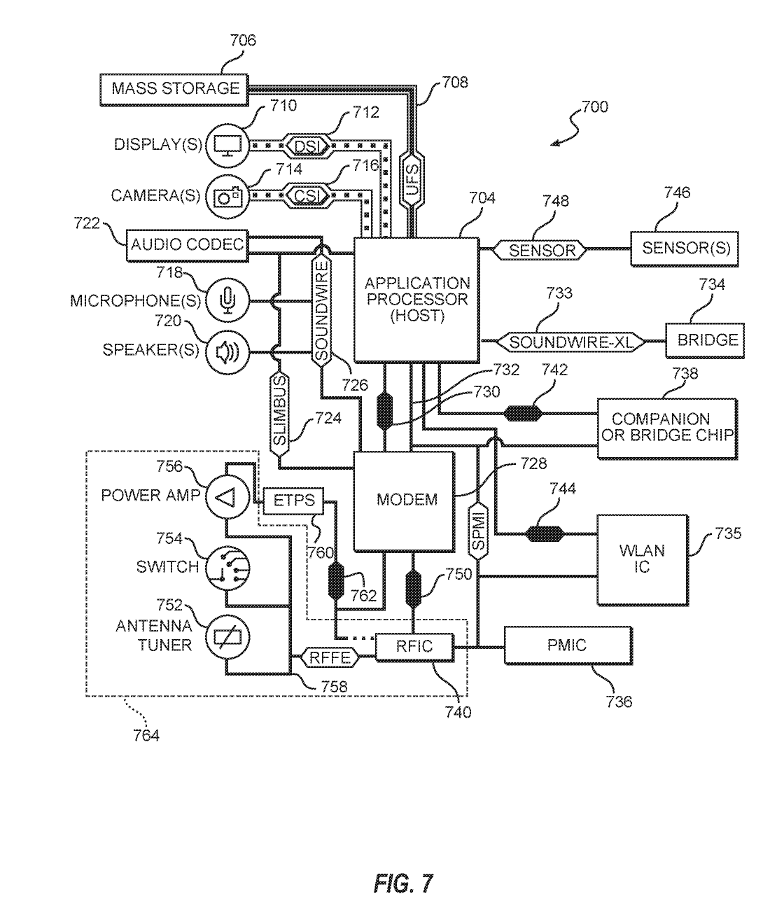

To provide a system-level block diagram of an exemplary device employing a SOUNDWIRE Extension bus, FIG. 7 is provided. FIG. 7 illustrates elements of an exemplary mobile terminal 700 such as a smart phone, mobile computing device tablet, or the like. While a mobile terminal having a SOUNDWIRE Extension bus is particularly contemplated as being capable of benefiting from exemplary aspects of the present disclosure, it should be appreciated that the present disclosure is not so limited and may be useful in any system having a time division multiplexed (TDM) bus.

With continued reference to FIG. 7, the mobile terminal 700 includes an application processor 704 (sometimes referred to as a host) that communicates with a mass storage element 706 through a universal flash storage (UFS) bus 708. The application processor 704 may further be connected to a display 710 through a display serial interface (DSI) bus 712 and a camera 714 through a camera serial interface (CSI) bus 716. Various audio elements such as a microphone 718, a speaker 720, and an audio codec 722 may be coupled to the application processor 704 through a serial low-power interchip multimedia bus (SLIMbus) 724. Additionally, the audio elements may communicate with each other through a SOUNDWIRE bus 726. A modem 728 may also be coupled to the SLIMbus 724 and/or the SOUNDWIRE bus 726. The modem 728 may further be connected to the application processor 704 through a peripheral component interconnect (PCI) or PCI express (PCIe) bus 730 and/or a system power management interface (SPMI) bus 732. The application processor 704 may also communicate via a SOUNDWIRE Extension bus, such as a SOUNDWIRE-XL bus 733, with a bridge 734 (e.g., the bridge 326 of FIG. 3, as a non-limiting example).

With continued reference to FIG. 7, the SPMI bus 732 may also be coupled to a local area network (LAN) or a wireless local area network (WLAN) IC (LAN IC or WLAN IC) 735, a power management integrated circuit (PMIC) 736, a companion IC (sometimes referred to as a bridge chip) 738, and a radio frequency IC (RFIC) 740. It should be appreciated that separate PCI buses 742 and 744 may also couple the application processor 704 to the companion IC 738 and the WLAN IC 735. The application processor 704 may further be connected to sensors 746 through a sensor bus 748. The modem 728 and the RFIC 740 may communicate using a bus 750.

With continued reference to FIG. 7, the RFIC 740 may couple to one or more RFFE elements, such as an antenna tuner 752, a switch 754, and a power amplifier 756 through a radio frequency front end (RFFE) bus 758. Additionally, the RFIC 740 may couple to an envelope tracking power supply (ETPS) 760 through a bus 762, and the ETPS 760 may communicate with the power amplifier 756. Collectively, the RFFE elements, including the RFIC 740, may be considered an RFFE system 764. It should be appreciated that the RFFE bus 758 may be formed from a clock line and a data line (not illustrated).

Providing zero-overhead frame synchronization using synchronization strobe polarity for SOUNDWIRE Extension buses according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

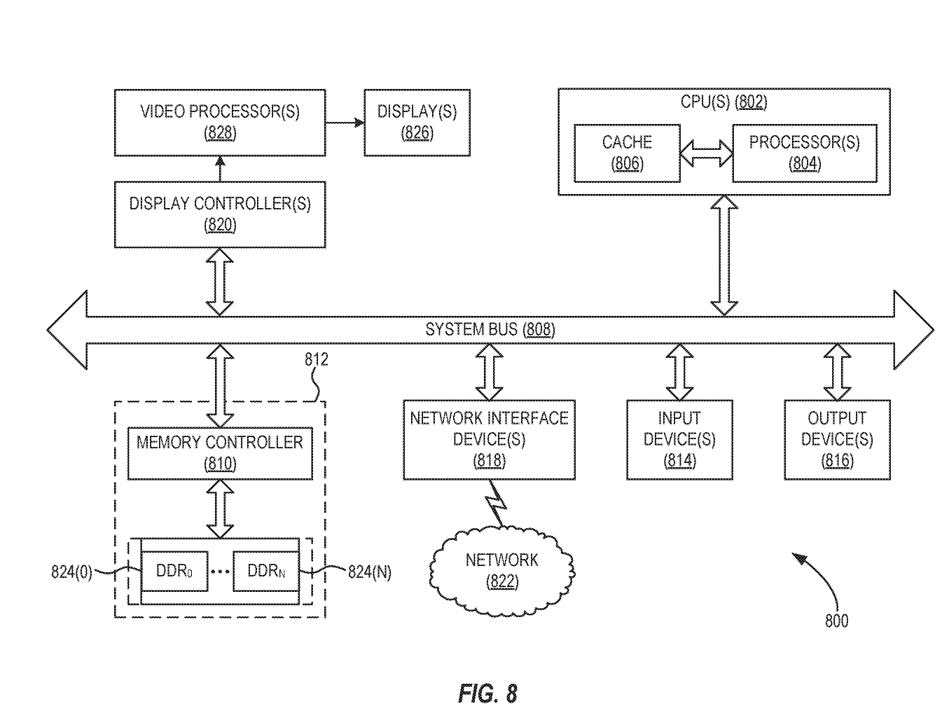

In this regard, FIG. 8 illustrates an example of a processor-based system 800 that may comprise the processor-based DFI device 300 and/or the processor-based UFI device 302 of FIG. 3. The processor-based system 800 includes one or more CPUs 802, each including one or more processors 804. The CPU(s) 802 may have cache memory 806 coupled to the processor(s) 804 for rapid access to temporarily stored data. The CPU(s) 802 is coupled to a system bus 808 and can intercouple master and slave devices included in the processor-based system 800. As is well known, the CPU(s) 802 communicates with these other devices by exchanging address, control, and data information over the system bus 808. For example, the CPU(s) 802 can communicate bus transaction requests to a memory controller 810 as an example of a slave device.

Other master and slave devices can be connected to the system bus 808. As illustrated in FIG. 8, these devices can include a memory system 812, one or more input devices 814, one or more output devices 816, one or more network interface devices 818, and one or more display controllers 820, as examples. The input device(s) 814 can include any type of input device, including but not limited to input keys, switches, voice processors, etc. The output device(s) 816 can include any type of output device, including, but not limited to, audio, video, other visual indicators, etc. The network interface device(s) 818 can be any devices configured to allow exchange of data to and from a network 822. The network 822 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 818 can be configured to support any type of communications protocol desired. The memory system 812 can include one or more memory units 824(0)-824(N).

The CPU(s) 802 may also be configured to access the display controller(s) 820 over the system bus 808 to control information sent to one or more displays 826. The display controller(s) 820 sends information to the display(s) 826 to be displayed via one or more video processors 828, which process the information to be displayed into a format suitable for the display(s) 826. The display(s) 826 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A processor-based downstream-facing interface (DFI) device, comprising an application processor comprising a control circuit and a bus interface, and communicatively coupled to a bus;
the application processor configured to:
determine, by the control circuit of the application processor, a polarity of a next synchronization strobe of a bitstream based on a value of a next frame synchronization pattern;
adjust the next synchronization strobe of the bitstream to comprise a signal transition corresponding to the polarity; and
transmit the bitstream containing the next synchronization strobe via the bus.

2. The processor-based DFI device of claim 1, wherein the application processor is configured to adjust the next synchronization strobe of the bitstream to comprise the signal transition corresponding to the polarity by being configured to:
determine whether the next frame synchronization pattern has a value of zero (0) or a value of one (1);
responsive to determining that the next frame synchronization pattern has a value of zero (0), adjust the next synchronization strobe to comprise a low-to-high signal transition; and
responsive to determining that the next frame synchronization pattern has a value of one (1), adjust the next synchronization strobe to comprise a high-to-low signal transition.

3. The processor-based DFI device of claim 1, wherein the application processor is configured to adjust the next synchronization strobe of the bitstream to comprise the signal transition corresponding to the polarity by being configured to:
determine whether the next frame synchronization pattern has a value of zero (0) or a value of one (1);
responsive to determining that the next frame synchronization pattern has a value of one (1), adjust the next synchronization strobe to comprise a low-to-high signal transition; and
responsive to determining that the next frame synchronization pattern has a value of zero (0), adjust the next synchronization strobe to comprise a high-to-low signal transition.

4. The processor-based DFI device of claim 1, wherein the application processor is configured to transmit the bitstream containing the next synchronization strobe via the bus by being configured to repurpose a frame synchronization pattern bitslot of the bitstream to store one of a control bit and a data bit.

5. The processor-based DFI device of claim 1, wherein the application processor is configured to transmit the bitstream containing the next synchronization strobe via the bus by being configured to transmit the bitstream via the bus using a SOUNDWIRE Extension protocol.

6. The processor-based DFI device of claim 1 integrated into an integrated circuit (IC).

7. The processor-based DFI device of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

8. A method for encoding frame synchronization patterns, comprising:
determining, by a downstream-facing interface (DFI) device, a polarity of a next synchronization strobe of a bitstream based on a value of a next frame synchronization pattern;
adjusting the next synchronization strobe of the bitstream to comprise a signal transition corresponding to the polarity; and
transmitting the bitstream containing the next synchronization strobe via a bus.

9. The method of claim 8, wherein adjusting the next synchronization strobe of the bitstream to comprise the signal transition corresponding to the polarity comprises:
determining whether the next frame synchronization pattern has a value of zero (0) or a value of one (1);
responsive to determining that the next frame synchronization pattern has a value of zero (0), adjusting the next synchronization strobe to comprise a low-to-high signal transition; and
responsive to determining that the next frame synchronization pattern has a value of one (1), adjusting the next synchronization strobe to comprise a high-to-low signal transition.

10. The method of claim 8, wherein adjusting the next synchronization strobe of the bitstream to comprise the signal transition corresponding to the polarity comprises:
determining whether the next frame synchronization pattern has a value of zero (0) or a value of one (1);
responsive to determining that the next frame synchronization pattern has a value of one (1), adjusting the next synchronization strobe to comprise a low-to-high signal transition; and
responsive to determining that the next frame synchronization pattern has a value of zero (0), adjusting the next synchronization strobe to comprise a high-to-low signal transition.

11. The method of claim 8, wherein transmitting the bitstream containing the next synchronization strobe via the bus comprises repurposing a frame synchronization pattern bitslot of the bitstream to store one of a control bit and a data bit.

12. The method of claim 8, wherein transmitting the bitstream containing the next synchronization strobe via the bus comprises transmitting the bitstream via the bus using a SOUNDWIRE Extension protocol.

13. A processor-based upstream-facing interface (UFI) device, comprising an application processor comprising a control circuit and a bus interface, and communicatively coupled to a bus;
the application processor configured to:
receive, by the control circuit of the application processor, a bitstream comprising a synchronization strobe via the bus;
detect a polarity of the synchronization strobe indicated by a signal transition of the synchronization strobe;
reconstruct a frame synchronization pattern based on the polarity of the synchronization strobe; and
perform frame synchronization based on the frame synchronization pattern.

14. The processor-based UFI device of claim 13, wherein the application processor is configured to reconstruct the frame synchronization pattern based on the polarity of the synchronization strobe by being configured to:
determine whether the polarity of the synchronization strobe comprises a low-to-high signal transition or a high-to-low signal transition;
responsive to determining that the polarity of the synchronization strobe comprises a low-to-high signal transition, detect the polarity as indicating a frame synchronization pattern of zero (0); and
responsive to determining that the polarity of the synchronization strobe comprises a high-to-low signal transition, detect the polarity as indicating a frame synchronization pattern of one (1).

15. The processor-based UFI device of claim 13, wherein the application processor is configured to reconstruct the frame synchronization pattern based on the polarity of the synchronization strobe by being configured to:
determine whether the polarity of the synchronization strobe comprises a low-to-high signal transition or a high-to-low signal transition;
responsive to determining that the polarity of the synchronization strobe comprises a low-to-high signal transition, detect the polarity as indicating a frame synchronization pattern of one (1); and
responsive to determining that the polarity of the synchronization strobe comprises a high-to-low signal transition, detect the polarity as indicating a frame synchronization pattern of zero (0).

16. The processor-based UFI device of claim 13, wherein the application processor is configured to receive the bitstream comprising the synchronization strobe via the bus by being configured to receive the bitstream via the bus using a SOUNDWIRE Extension protocol.

17. The processor-based UFI device of claim 13 integrated into an integrated circuit (IC).

18. The processor-based UFI device of claim 13 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

19. A method for decoding frame synchronization patterns, comprising:
receiving, by a processor-based upstream-facing interface (UFI) device, a bitstream comprising a synchronization strobe via a bus;
detecting a polarity of the synchronization strobe indicated by a signal transition of the synchronization strobe;
reconstructing a frame synchronization pattern based on the polarity of the synchronization strobe; and
performing frame synchronization based on the frame synchronization pattern.

20. The method of claim 19, wherein reconstructing the frame synchronization pattern based on the polarity of the synchronization strobe comprises:
determine whether the polarity of the synchronization strobe comprises a low-to-high signal transition or a high-to-low signal transition;
responsive to determining that the polarity of the synchronization strobe comprises a low-to-high signal transition, detecting the polarity as indicating a frame synchronization pattern of zero (0); and
responsive to determining that the polarity of the synchronization strobe comprises a high-to-low signal transition, detecting the polarity as indicating a frame synchronization pattern of one (1).

21. The method of claim 19, wherein reconstructing the frame synchronization pattern based on the polarity of the synchronization strobe comprises:
determining whether the polarity of the synchronization strobe comprises a low-to-high signal transition or a high-to-low signal transition;
responsive to determining that the polarity of the synchronization strobe comprises a low-to-high signal transition, detecting the polarity as indicating a frame synchronization pattern of one (1); and
responsive to determining that the polarity of the synchronization strobe comprises a high-to-low signal transition, detecting the polarity as indicating a frame synchronization pattern of zero (0).

22. The method of claim 19, wherein receiving the bitstream comprising the synchronization strobe via the bus comprises receiving the bitstream via the bus using a SOUNDWIRE Extension protocol.
